(19) United States
(12) Patent Application Publication
(10) Pub. No.: US 2004/0050484 A1
(43) Pub. Date: Mar. 18, 2004

(54) Methods for producing a data carrier

(76) Inventors: Ulrich Speer, Eisingen (DE); Frank Michels, Knittlingen (DE)

Correspondence Address: Robert W. Becker, Robert Becker & Associates, Suite B, 707 Hwy 66 East, Tijeras, NM, 87059-7382, US

(21) Appl. No.: 10/250,795

(22) PCT Filed: Dec. 13, 2001
(86) PCT No.: PCT/EP01/14658

(30) Foreign Application Priority Data
Jan. 8, 2001 (DE) 101 00 430.3

(51) Int. Cl. G11B 7/00; B32B 31/00

(52) U.S. Cl. 156/269; 156/324

(57) ABSTRACT

The information relates to simple, cost-effective methods for the production of an optical data carrier comprising a plurality of information carrying layers. According to the invention, several information carrying films are glued to a substrate and/or glued to each other.

The present invention relates to a method for producing an optical data carrier having a plurality of information-carrying foils or films.

Known data carriers, such as, for example, DVDs, have two information-carrying layers that are applied to respective rigid support substrates that are glued together to form the data carrier. The gluing is effected, for example, with an adhesive film that is laminated to one of the substrates, as is known from DE-A-100 29 400, which originates with the same applicant. With this known method, however, it is not possible to provide a plurality of information-carrying layers directly over one another, since the information-carrying layers are respectively provided on a rigid support substrate.

Proceeding from the known state of the art, it is therefore an object of the present invention to provide a method that in a simple and economical manner enables the production of an optical data carrier having a plurality of information-carrying layers, according to which a plurality of data-carrying layers are disposed adjacent one another.

Pursuant to the invention, this object is realized with a method of producing an optical data carrier having a plurality of information-carrying foils or films with the following method steps: applying a double-sided adhesive film to a first film, aligning a second film with the first film, and joining the films together to form a film set.

As a result of the direct joining-together of two information-carrying films with merely an adhesive film disposed therebetween, it is possible in a simple and economical manner to form an optical data carrier having a plurality of information-carrying films, without these films having to be respectively secured to a support substrate.

Pursuant to a preferred embodiment of the invention, the film set, by repeating the above steps, is glued to at least one further film or at least one further film set, as a result of which, in a simple and economical manner, there results the build-up of an optical data carrier having a desired number of information-carrying layers or films.

The object of the invention is also realized with a method of producing an optical data carrier having a plurality of information-carrying films with the following method steps: applying a double-sided adhesive film to a support substrate, aligning at least one film with the support substrate, joining the film together with the support substrate, and repeating the steps a) to c) to build-up the data carrier. With this method, the required number of information-carrying layers are achieved in that information-carrying films are laminated one above the other on a support substrate. The laminating process can be repeated until the required number of information-carrying layers is achieved. To speed up the production of the optical data carrier, at least one film is a film set that comprises a plurality of glued-together films. In this way, in a single laminating step a plurality of information-carrying layers can be built up onto the support substrate, or the films laminated thereon.

The stated object is also realized with a method of producing an optical data carrier having a plurality of information-carrying films with the following method steps: aligning a first film, which is coated at least on one side with adhesive, with a second film, and joining the films together to form a film set. There again results in a simple and economical manner the possibility of providing a plurality of information-carrying layers by directly joining information-carrying films together. Due to the fact that one film is coated on at least one side with adhesive, the films can be joined directly together without previously applying a separate adhesive.

By repeating the above-mentioned steps, the film set is preferably glued to at least one further film that is coated on at least one side with adhesive, as a result of which the film set can be built up further in order to achieve the required number of information-carrying layers or films.

Pursuant to an alternative embodiment of the invention, by repeating the above mentioned steps the film set is glued to at least one further film set, whereby at least one film set has a surface coated with adhesive. By joining two films sets together that comprise at least two information-carrying films, the number of required information-carrying layers or films can be achieved even more rapidly.

Pursuant to a particularly preferred embodiment of the invention, the films are respectively coated on one side with adhesive and during the joining together respectively one uncoated surface of a film is joined together with a coated surface of the other film, as a result of which a film set automatically results that is coated on one surface with adhesive, and thus can easily be joined together with a further film, a film set or a support substrate.

The objective is realized with a method of producing an optical data carrier having a plurality of information-carrying films by the following method steps: aligning a first film, which is coated on at least one side with adhesive, with a support substrate, joining the film and the support substrate together, and repeating the above steps to build up the data carrier. It is again possible in an easy and economical manner to build up a data carrier having a plurality of information-carrying layers or films on a support substrate. Due to the fact that the information-carrying film is coated on at least one side with adhesive, the step of applying an adhesive to the film or the support substrate is eliminated, which enables a rapid build-up of the data carrier.

To further speed up the build-up of the data carrier, the film is preferably a film set that comprises a plurality of already joined together films. These films can, for example, be joined together to film sets in the manner already described above. Pursuant to a particularly preferred embodiment of the invention, the films contain fluorescing material, since this can easily be stimulated by a light source, such as, for example, a laser, and generally radiates back with a different wave length than the stimulating light source, as a result of which interferences between reflecting laser radiation and the radiation emitted from the fluorescing material can be avoided.

Pursuant to an embodiment of the invention, during or after the application of the film to a further film, a film set or a support substrate, a support film is withdrawn from the film, which support film has a required stability to enable transport of the film. The support film furthermore prevents a premature gluing of one side of the film to other objects as well as contamination thereof. Prior to the application of the film, a protective film is preferably withdrawn from that side of the film disposed opposite the support film, which prevents a contamination of the other side prior to the gluing.

In order to ensure a good and uniform gluing of the films, they have shapes and sizes that correspond to one another. This ensures that the films are glued to one another over their entire surface. In this connection, film sections are provided that preferably correspond to the shape and size of the data carrier, and that are, for example, stamped-out on the support film. Pursuant to an alternative embodiment of the invention, the shape and size of the data carrier are stamped out after the joining together of the films or the joining of the films with the support substrate.

To avoid air pockets or bubbles between the films or between the films and the support substrate, the joining together is preferably effected via at least one rotatable pressure roller. In this way, a controlled joining together is achieved along a straight line, and there furthermore results a constant process progress that can essentially be carried out continuously.

The pressure during the joining together is preferably controlled in order to ensure good and uniform gluing of the films to one another or with the support substrate.

Prior to the joining together, the films are advantageously held at a prescribed angle relative to one another or to the surface of the support substrate in order to prevent a premature joining together. The adhesive is preferably an adhesive that responds to pressure and/or the laminating speed, whereby adhesive here means not only the double-sided adhesive film but also the adhesive coated on one side of a film. Pursuant to one embodiment of the invention, the adhesive is cured after the joining together in order to provide a desired stability. Pursuant to a particularly preferred embodiment of the invention, the adhesive film comprises a single layer of adhesive material, in other words, without a support substrate that is coated on both sides with adhesive. In this way, the optical characteristics of the data carrier can be considerably improved.

The invention will be described subsequently in greater detail with the aid of preferred embodiments with reference to the drawing.

The drawing shows:

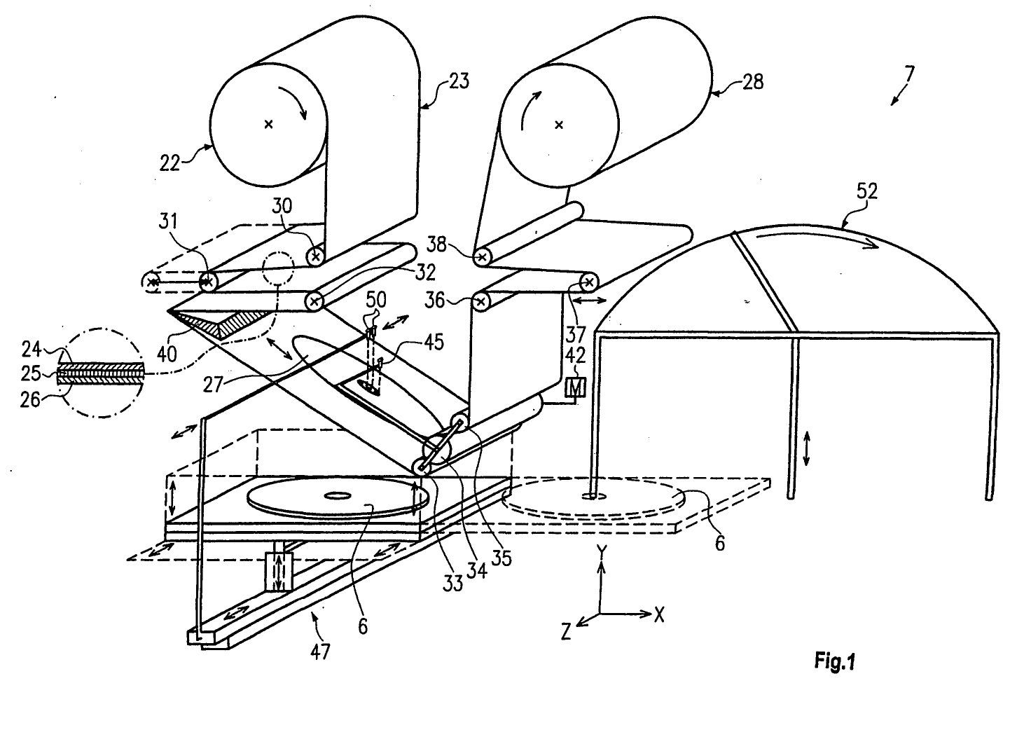

FIG. 1 a schematic perspective view of parts of a laminating station pursuant to the present invention;

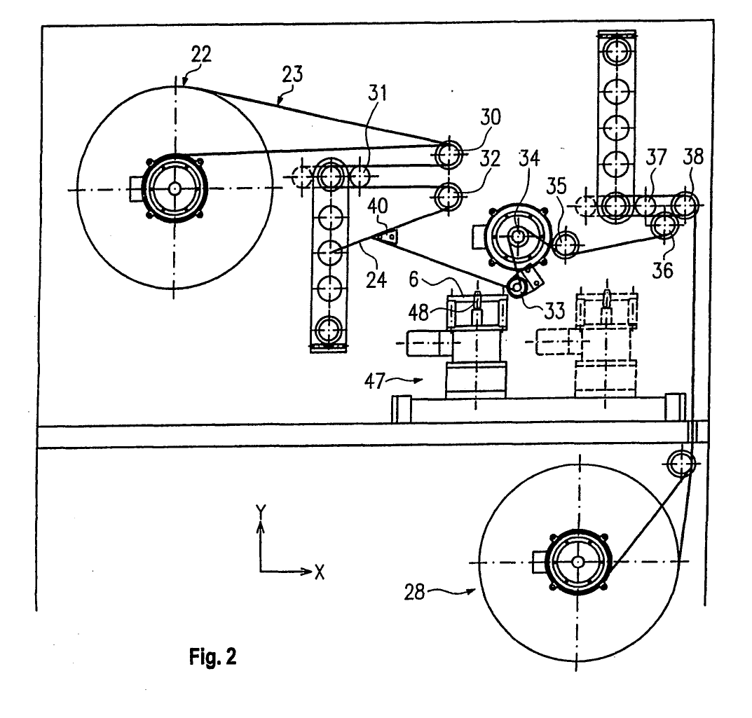

FIG. 2 a schematic side view of an alternative laminating station pursuant to the invention;

FIG. 3 a schematic side view of an alternative embodiment of a laminating station pursuant to the invention;

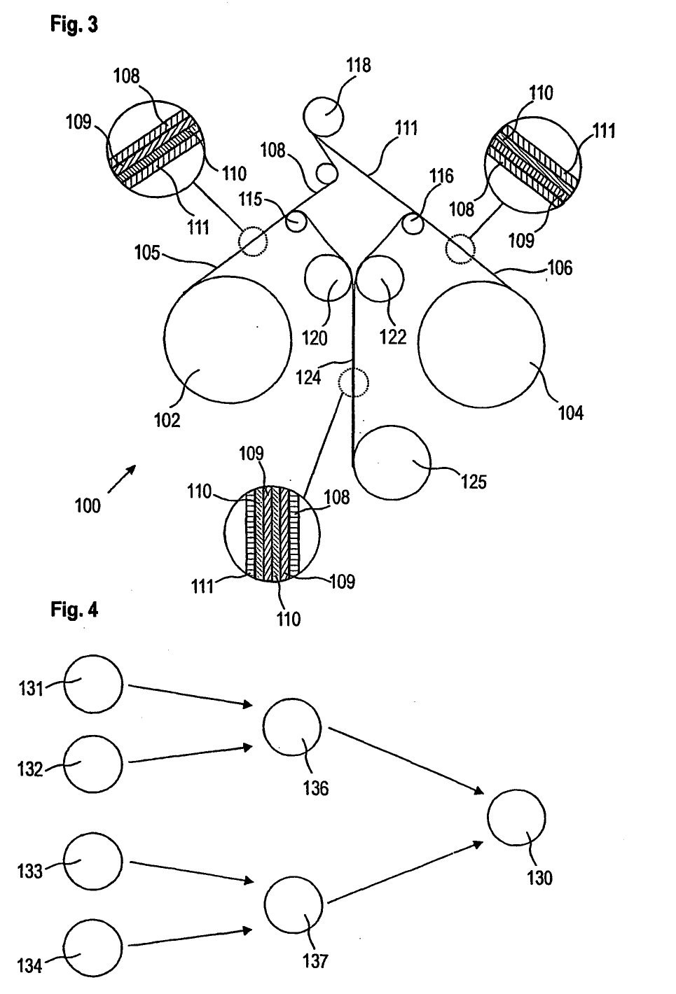

FIG. 4 a schematic diagram that illustrates the joining together of information-carrying films to form film sets;

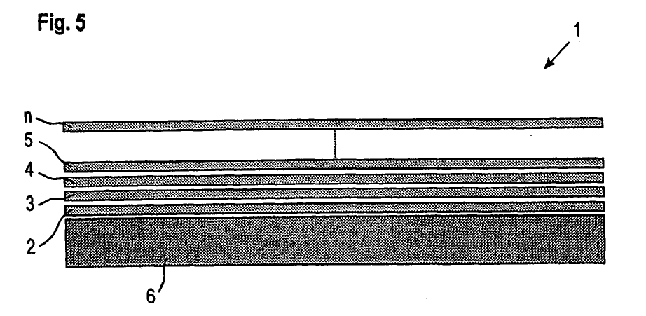

FIG. 5 a schematic side view of a data carrier that was built-up pursuant to the inventive method.

The present invention relates to the build-up of a data carrier 1, such as it is illustrated, for example, in FIG. 5. With the embodiment of a data carrier 1 illustrated in FIG. 5, a plurality of information-carrying films or foils 2,3,4,5 . . . n are provided that are disposed on a support substrate 6. One example of an information-carrying laminating film or foil is a film that contains a flourescing material, whereby the fluorescing material is embodied as an information carrier. The support substrate 6 is any suitable material that imparts to the information-carrying film 2,3,4,5 . . . n an adequate stability and that protects against damage. The uppermost information-carrying film n can be covered by a light-transparent substrate in order to protect the films.

To the extent that the films 2,3,4,5 . . . n provide an adequate stability for the data carrier, and no additional protection against external influences is required, the films can also form an appropriate carrier without a support substrate 6, as will be described subsequently.

FIGS. 1 and 2 show schematic illustrations of a laminating station 7 pursuant to the present invention, whereby the laminating stations 7 shown in FIGS. 1 and 2 partially have different arrangements of the respective components. In the following description of the laminating stations of FIGS. 1 and 2, however, the same reference numerals are used to the extent that identical or comparable components are described.

The laminating station 7 has a supply roller 22 upon which is rolled a strip-like laminating film or foil 23. Pursuant to a first embodiment, according to which an information-carrying film is applied to a support substrate by means of a double-sided adhesive film, the laminating film 23 comprises a total of three films, namely a protective film 24, a double-sided adhesive film (adhesive layer) 25 and a support film 26, as can be best recognized in the enlarged circular portion in FIG. 1. The adhesive film 25 has sections 27 that are stamped out in conformity with the size and shape of a surface of a support substrate 6 that is to be glued. The adhesive layer is a pressure-sensitive adhesive film, which is commonly designated as PSA tape, the adhesion properties of which can be adjusted via the pressure that is used and/or the laminating speed.

The laminating station is furthermore provided with a receiving roller 28 which receives the remainder of the laminating film 23 after a laminating process. The laminating film 23 is guided about a plurality of guide rollers 30 to 38 between the supply roller 22 and the receiving roller 28 in order to provide a defined path of movement of the strip-like laminating film 23 between the rollers 22 and 28. The respective rollers 30 to 38 are rotatable about their respective axes of rotation, and the rollers 31 and 37 are embodied as so-called compensating rollers that are moveably mounted in the horizontal direction in order to enable the compensation of length of the laminating film 23 between the rollers 22 and 28. In this way, the rollers 22 and 28 can be rotated at a constant speed despite discontinuous laminating cycles, as will be described subsequently. The not-needed parts of the adhesive film 25 can be removed previously, i.e. prior to introducing the laminating film into the laminating station, e.g. during the manufacture of the laminating film, or they can remain on the film in order to ensure a uniform thickness of the film 23 over the entire width and length thereof, at least prior toga laminating process.

The laminating film 23 is furthermore guided about a wedge-shaped doctor blade 40 at which the laminating film 23 is abruptly redirected in order to enable a removal of the protective film 24 from the laminating film 23, so that one side of the adhesive film 25 is exposed for the gluing of the support substrate 6. The removal of the protective film 24 can be best seen in FIG. 2. After the removal, the protective film 24 is rolled onto a non-illustrated roller. Instead of the wedge-shaped doctor blade 40, an alternative shape of a film-removing device can also be used.

After the laminating film 23 is guided about the doctor blade 40, it is guided at an angle relative to a horizontal about the lower roller 33, which is embodied as a pressure roller. After the roller 33, the laminating film 23 is guided about the shaft 34, which is driven by a motor 42.

In this connection, a rotation of the driven roller 34 effects a corresponding rotation of the pressure roller 33 as well as of a following roller 35, which is embodied as a true guide roller.

The laminating station 7 has a first sensor 45 that is associated with the driven roller 34 and is in a position to detect contours of the stamped-out sections 27 of the adhesive film 25. The laminating,film 23 is moved back and forth in the longitudinal direction via the driven roller 34 until the sensor 45 recognizes a specific contour of the stamped-out section 27, such as, for example, a stamped-out central hole. If the sensor 45 recognizes the central hole, it is positioned, by movement of the film, directly over an edge of the central hole, as a result of which a precise orientation of the section 27 relative to the roller 34, and in particular to the pressure roller 33, in the longitudinal direction of the laminating film 23 is provided.

The laminating station 7 is provided with a support and transport unit 47 for the support substrate 6 that is to be laminated. The support and transport unit 47 forms a horizontal support for the support substrate 6 and is moveable in all directions via suitable non-illustrated movement mechanisms. By means of a centering pin 48 that can be lowered, a precise orientation or alignment of the support substrate 6 upon the support and transport unit 47 is ensured. The pin 48 can be lowered so as not to adversely affect the laminating process. This is achieved in that it is pressed upwardly into the position shown in FIG. 3 by a spring having a relatively low spring force. With a pressure onto the pin from above, it is pressed downwardly against the spring force. Alternatively, the pin can also be moved by a cylinder or a motor.

Prior to the lamination of the substrate support 6, the transport and support unit 47 is moved in the X direction, which corresponds to the longitudinal direction of the laminating film 23, against an abutment. This ensures that the support substrate 6, and the section 27 of the adhesive film 25 that was previously aligned in the longitudinal direction, are aligned relative to one another. The transport and support unit 47 is subsequently moved back and forth in the Z direction, which extends transverse to the longitudinal direction of the laminating film 23. By means of a sensor pair 50 that is associated with the transport and support unit 47, a contour, for example the contour of a central hole, of the stamped-out section 27 of the adhesive film 25 is detected, which enables a lateral alignment of the support substrate relative to the section 27.

After the support substrate 6 is aligned in the above manner not only in the X direction but also in the Z direction relative to the section 27 of the adhesive film 25, the transport and support unit 47 is raised in the Y direction. The roller 34 is now driven by the motor 32, which causes the laminating film 23 to move in the X direction. At the same time, and synchronized with the rotation, the transport and support unit 47 is moved in the X direction. In so doing, the section 27 comes into contact with the surface of the support substrate 6 that is to be glued, and is pressed thereagainst by the pressure roller 33, so that it adheres to the support substrate 6 and is released from the support film 26. As a consequence of the synchronized movement of the drive roller 34 with the transport and support unit 47, a section 27 of the adhesive film 25 is applied in a centered manner to the substrate half 6, so that the section 27 of the film 25 completely covers the side of the support substrate 6 that is to be glued, and does not extend beyond the edge. The pressure of the pressure roller is controlled by the position of the transport and support unit 47 in the Y direction in order to set the adhesion properties of the adhesive film 25. Alternatively, it is, of course, also possible to move the pressure roller 33 in the direction of the transport and support unit. For a good setting or compensation of the pressure, an elastic suspension system can be provided. The elastic suspension can be effected by a spring or a compressed air cylinder.

Subsequently, the support substrate 6, which is thus provided with the section 27 of the adhesive film 25, is removed from the transport and support unit 47 via a suitable handling device 52, such as an inner hole gripper, and is transported to a further laminating station in which an information-carrying film is laminated on. The further laminating station can have essentially the same construction, whereby in this case the laminating film is built up from a protective film, an information-carrying film, and a support film. In the above manner, further films can also be laminated onto the support substrate until the required number of information-carrying films (layers) is achieved.

In the first laminating station, a new support substrate 6 is loaded upon the transport and support unit 47, and the laminating process is repeated. As already mentioned above, the rollers 22 and 28 rotate continuously during the entire process, although the adhesion process does not run continuously. The length compensation of the laminating film 23 that is therefore required is, as already mentioned, achieved via a horizontal movement of the compensating rollers 31 and 37.

Although the laminating film of the foregoing description has three layers, namely a protective film 24, an adhesive film (an information-carrying film) 25 and a support film 26, it should be noted that a protective film 24 is not absolutely necessary. However, if no protective film 24 is used, at least the rollers 30 and 32 should be specially coated in order to prevent a gluing and/or a contamination of the then exposed adhesive film (information-carrying film) 25 against these rollers.

Furthermore, the adhesive film 25 also need not be a pressure sensitive film, and it can also be formed by a double-sided, coated carrier material instead of a single adhesive layer.

Alternatively, the rollers, with the exception of the roller 33, can also be eliminated, whereby in this case the rollers 22 and 28 must be controlled in such a way that an alignment of these sections 27, as well as a movement of the laminating film 23 synchronized with the transport and support unit 47, are achieved.

Instead of the sensors 45 and 50, a single sensor, for example a camera, could also be utilized for the above alignment procedures. With different shapes of the support substrate, such as, for example, a check card, where a precise alignment of the information-carrying films is not necessary, the sensors can be entirely eliminated. Furthermore, it is possible to laminate the information-carrying films onto a support substrate essentially having any desired shape that is at least as large as the information-carrying foil, and only after the laminating-on to form the desired shape of the data carrier, for example by a stamping-out process. In this case, it is advantageous if the support substrate is as long as possible in order to enable a continuous laminating process.

The laminating station described with reference to FIGS. 1 and 2 can also be used with an information-carrying film that is coated with adhesive on one side. Instead of the alternating lamination of a double-sided adhesive film and an information-carrying film onto the support substrate 6, the information-carrying film can be laminated directly onto the support substrate 6. In this case, the laminating film comprises a protective film, an information-carrying film that, facing the protective film, is coated on one side with an adhesive, and a support film. After the removal of the protective film, the surface of the information-carrying film that is coated on one side is exposed and can be laminated directly onto the support substrate. By appropriate movement of the transport and support unit 47, it is possible in the same laminating station to successively laminate any number of information-carrying films onto the support substrate.

FIG. 3 shows an alternative embodiment of the invention according to which two information-carrying films are joined directly together, i.e. without being laminated onto a support substrate. The laminating apparatus 100 of FIG. 3 has first and second supply rollers 102, 104 onto which the respective strip-like laminating film 105 and 106 is rolled. The laminating film 105 comprises a support film 108, an information-carrying film 109, that surface of which that faces away from the support film 108 is coated with an adhesive material 110, as well as a protective film 111 that adheres to the adhesive material 110, as can be recognized best in the encircled portion at the left in FIG. 3. The laminating film 106 has the same configuration as does the laminating film 105, which can be recognized in the encircled portion at the right in FIG. 3. The laminating film 105 is wound onto the supply roller 102 in such a way that the surface of the information-carrying film 109 that is coated with adhesive material 110 is directed inwardly, while the laminating film 106 is wound onto the supply roller 104 in the reverse manner.

The apparatus 100 furthermore has two reversing or guide rollers 115, 116 at which the direction of the laminating films 105 and 106 that are unwound from the supply rollers 102, 104 is changed. This change in direction enables a withdrawal of the support film 108 from the laminating film 105, and a withdrawal of the protective film 111 from the laminating film 106. The films 108, 111 withdrawn from the respective laminating films are wound onto a common receiving roller 118 in order to be subsequently disposed of. Of course, the respective films can also be wound onto separate rollers.

After the direction of the laminating film 105 has been changed, the information-carrying film 109 is exposed, while the adhesive material 110 of the laminating film 106 is exposed. The remaining portions of the respective laminating films 105, 106 are pressed together between two rotatable pressure rollers 120, 122. The two laminating films are thus glued to one another, and in particular in such a way that the exposed adhesive material 110 of the laminating roller 106 is glued to the information-carrying film 109 of the laminating film 105. The thereby resulting film set or package is formed by a protective layer, 111, an adhesive layer 110 disposed adjacent thereto, an information-carrying film 109, an adhesive layer 110, a second information-carrying film 109 and a support film 108. This film set or package 124 is wound onto a receiving roller 125, and can subsequently be glued in a suitable manner with a support substrate, a further laminating film 105, 106 and/or a further film set 124.

FIG. 4 schematically shows the build-up of a film set or package 130 that comprises a total of four films, which can, for example, have the configuration of the above laminating films 105, 106. Initially, two films 131, 132 are glued together to form a first film set or package 136. At the same time, two films 133, 134 can be glued together to form a second film set or package 137. Subsequently, the two film sets 136, 137 are glued together to form the film set or package 139, which comprises four films. For the respective gluing procedures, the laminating apparatus described in conjunction with FIG. 3 can be used. In this manner, film sets having any number of films can be formed.

The laminating films 105, 106 described in FIG. 3 each have an information-carrying film 109 coated on one side with adhesive material 110. However, it is alternatively also possible to provide non-coated information-carrying films, at least one of which is initially brought together with a double-sided adhesive film (adhesive layer) and only subsequently glued to the further information-carrying film. It is, of course, also possible to laminate the information-carrying films essentially simultaneously onto a double-sided adhesive film.

The film sets formed by the above laminating processes can be applied to a carrier substrate in any suitable manner, such as by being laminated on. The shape of the data carrier to be formed can be subsequently stamped-out. Alternatively, the laminating films 105, 106 can respectively have stamped-out sections of the information-carrying film 109 that are joined together between the rollers 120, 122. In this connection, a precise control of the movement of the laminating films 105, 106 between the pressure rollers 120, 122 is necessary in order to ensure an alignment of the stamped-out sections.

The invention was previously described with the aid of preferred embodiments of the invention, without, however, being limited to the concretely illustrated embodiments. For example, it is possible, with the embodiments described with reference to FIGS. 1 and 2, instead of individual films to laminate film sets onto a support substrate, such as film sets produced pursuant to the embodiment of FIGS. 3 and 4. In addition, the construction of the laminating stations can differ from the illustrated embodiments, and elements of a laminating station can, to the extent that they are compatible, also be used in other laminating stations. The information-carrying films can already to begin with be provided with the respective information, or they can be provided with information only later, for example they can be inscribed with a laser. The laminated-together films, or the films laminated onto a support substrate, can in an auxiliary station, which, for example, has a vacuum station, be additionally pressed together or glued to support substrates in order to stabilize the connection and possibly cure the adhesive material that is used. Preferably, at least three information-carrying films are glued together in the above manner. The above method is particularly suitable for building-up an FMD data carrier (fluorescent media device) where a plurality of layers are provided that contain fluorescing material.

1. Method of producing an optical data carrier having a plurality of information-carrying films, with the following method steps:
a. Applying a double-sided adhesive to a first film,
b. Aligning a second film with the first film, and
c. Joining the films together to form a film set.

2. Method according to claim 1, characterized in that the film set is glued to at least one further film or at least one further film set by the repetition of the steps a to c.

3. Method of producing an optical data carrier having a plurality of information-carrying films, with the following method steps:
a. Applying a double-sided adhesive to a support substrate,
b. Aligning at least one first film with the support substrate, and
c. Joining the films together with the support substrate, and
d. Repeating steps a to c to build up the data carrier.

4. Method according to claim 3, characterized in that at least one film is a film set.

5. Method of producing an optical data carrier having a plurality of information-carrying films, with the following method steps:
a. Aligning a first film, which is coated on at least one side with adhesive, with a second film, and
b. Joining the films together to form a film set.

6. Method according to claim 5, characterized in that the film set is glued with at least one further film that is coated on at least one side with adhesive by the repetition of the steps a and b.

7. Method according to claim 5 or 6, characterized in that the film set is glued to at least one further film set by the repetition of the steps a and b, whereby at least one film set has a surface coated with adhesive.

8. Method according to one of the claims 5 to 8, characterized in that the films are respectively coated on one side with adhesive, and during the joining together respectively one uncoated surface of a film is joined together with a coated surface of the other film.

9. Method of producing an optical data carrier having a plurality of information-carrying films, with the following method steps:
a. Aligning a first film, which is coated on at least one side with adhesive, with a support substrate,
b. Joining the film and the support substrate together, and
c. Repeating steps a and b to build up the data carrier.

10. Method according to claim 9, characterized in that the film is a film set.

11. Method according to one of the preceding claims, characterized in that the films contain fluorescing material.

12. Method according to one of the preceding claims, characterized in that during or after the application of the film to a further film, a film set or a support substrate, a support film is withdrawn from the film.

13. Method according to one of the preceding claims, characterized in that the shape and size of the films correspond to one another.

14. Method according to claim 13, characterized in that film sections are provided that correspond to the shape and size of the data carrier.

15. Method according to one of the preceding claims, characterized in that the shape and size of the data carrier is stamped out after the joining of the films together or of the films with the support substrate.

16. Method according to one of the preceding claims, characterized in that the films are joined together via at least one rotatable pressure roller.

17. Method according to one of the preceding claims, characterized in that the pressure is controlled during the joining together.

18. Method according to one of the preceding claims, characterized in that the films, prior to the joining together, are held at a prescribed angle relative to one another or to the surface of the support substrate.

19. Method according to one of the preceding claims, characterized in that the adhesive is an adhesive that responds to pressure and/or a laminating speed.

20. Method according to one of the preceding claims, characterized in that the adhesive is cured.

21. Method according to one of the preceding claims, characterized in that the double-sided adhesive film comprises a single layer of adhesive material.
